(19) United States
(12) Patent Application Publication
(10) Pub. No.: US 2026/0296963 A1
(43) Pub. Date: Oct. 1, 2026

(54) Gypsum Board Including a Gypsum Core with Crystals Having an Enhanced Aspect Ratio

(71) Applicant: Gold Bond Building Products, LLC, Charlotte, NC (US)

(72) Inventors: Joseph J. Bailey, Charlotte, NC (US); Ratnasabapathy Gurunathan Iyer, Charlotte, NC (US); Brian Bland, Matthews, NC (US); Eli Stav, Charlotte, NC (US)

(21) Appl. No.: 19/630,713

(22) Filed: Mar. 27, 2026

Related U.S. Application Data
(60) Provisional application No. 63/778,632, filed on Mar. 27, 2025.

(51) Int. Cl. C04B 11/00; B32B 13/08; C04B 28/14; C04B 111/00; E04C 2/04

(52) U.S. Cl. CPC C04B 11/00; B32B 13/08; C04B 28/14; E04C 2/043; B32B 2250/03; B32B 2250/40; B32B 2264/104; B32B 2264/308; B32B 2607/00; C04B 2111/0062

(57) ABSTRACT

The present disclosure is directed to a gypsum board and a method of making a gypsum board. The gypsum board comprises a gypsum core and a facing material. The gypsum core may include calcium sulfate dihydrate crystals having a length dimension and a lateral dimension transverse the length dimension, wherein the lateral dimension is less than 20% of the length dimension for at least 30% of the calcium sulfate dihydrate crystals.

### RELATED APPLICATIONS

The present application is based upon and claims priority to U.S. Provisional Patent Application Ser. No. 63/778,632, having a filing date of Mar. 27, 2025, which is incorporated herein by reference in its entirety.

### BACKGROUND

A building is typically constructed with walls having a frame comprising vertically oriented studs connected by horizontally oriented top and bottom plates or tracks. The walls often include one or more gypsum boards fastened to the studs and/or plates on each side of the frame or, particularly for exterior walls, one or more gypsum boards fastened to the studs and/or plates on one side of the frame with a non-gypsum based sheathing attached to an exterior side of the frame. A ceiling of the building may also include one or more gypsum boards oriented horizontally and fastened to joists, studs, or other structural members extending horizontally in the building. These gypsum boards typically include a gypsum core and facing materials on the major surfaces. The gypsum core includes calcium sulfate dihydrate crystals as well as other additives. Some of these additives are typically provided in order to improve the physical and mechanical properties of the board. However, the utilization of such additives can at times result in a less efficient manufacturing process as well as increased costs. In addition, such additives may have to be utilized in significant amounts in order to provide the necessary properties, while other additives may have deleterious effects.

As a result, there is still a need to further improve gypsum boards and the process of making said gypsum boards. Notably, manipulating the calcium sulfate dihydrate crystals may provide a gypsum core and resulting board with improved mechanical and physical properties.

### SUMMARY OF THE INVENTION

Aspects and advantages of the invention will be set forth in part in the following description, or may be obvious from the description, or may be learned through practice of the invention.

In accordance with one aspect of the present disclosure, a gypsum board is disclosed. The gypsum board comprises a gypsum core and a facing material, wherein the gypsum core includes calcium sulfate dihydrate crystals having a length dimension and a lateral dimension transverse the length dimension, wherein the lateral dimension is less than 20% of the length dimension for at least 30% of the calcium sulfate dihydrate crystals.

In some implementations, the lateral dimension is less than 20% of the length dimension for at least 50% of the calcium sulfate dihydrate crystals.

In some implementations, the lateral dimension is less than 20% of the length dimension for at least 75% of the calcium sulfate dihydrate crystals.

In some implementations, the lateral dimension is less than 15% of the length dimension for at least 50% of the calcium sulfate dihydrate crystals.

In some implementations, the lateral dimension is less than 15% of the length dimension for at least 75% of the calcium sulfate dihydrate crystals.

In some implementations, the lateral dimension is less than 10% of the length dimension for at least 30% of the calcium sulfate dihydrate crystals.

In some implementations, the lateral dimension is less than 10% of the length dimension for at least 50% of the calcium sulfate dihydrate crystals.

In some implementations, the lateral dimension is less than 10% of the length dimension for at least 75% of the calcium sulfate dihydrate crystals.

In some implementations, at least 30% of the calcium sulfate dihydrate crystals have an aspect ratio of more than 5.

In some implementations, at least 50% of the calcium sulfate dihydrate crystals have an aspect ratio of more than 5.

In some implementations, at least 75% of the calcium sulfate dihydrate crystals have an aspect ratio of more than 5.

In some implementations, at least 30% of the calcium sulfate dihydrate crystals have an aspect ratio of more than 10.

In some implementations, at least 75% of the calcium sulfate dihydrate crystals have an aspect ratio of more than 10.

In some implementations, at least 85% of the calcium sulfate dihydrate crystals have an aspect ratio of more than 10.

In some implementations, the gypsum core has a gypsum layer surface including a first gypsum layer surface and a second gypsum layer surface opposing the first gypsum layer surface, wherein the facing material includes a first facing material provided on the first gypsum layer surface and a second facing material provided on the second gypsum layer surface.

In some implementations, the gypsum core comprises a binder. In some implementations, the binder is present in an amount of from 0.0001 wt. % to 5 wt. % based on the weight of the gypsum board. In some implementations, the binder comprises an organic binder. In some implementations, the binder comprises a starch. In some implementations, the binder comprises an inorganic binder.

In some implementations, the calcium sulfate dihydrate crystals comprise from 50 wt. % to 98 wt. % of the gypsum core.

In some implementations, the calcium sulfate dihydrate crystals comprise from 70 wt. % to 98 wt. % of the gypsum core.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a gypsum board and a method of making such gypsum board. In particular, the gypsum board includes a gypsum core formed from a gypsum slurry. The gypsum core includes gypsum crystals (i.e., calcium sulfate dihydrate crystals) having a particular size and aspect ratio. The gypsum crystals of a gypsum core formed in accordance with the present disclosure may have a relatively high aspect ratio compared to the gypsum crystals of a traditional gypsum core.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that, unless stated otherwise, any standard listed herein (e.g., ASTM) is the most recent version available as of the latest revision year.

Notably, some aspects of the present disclosure may omit one or more of the features disclosed herein.

The gypsum crystals may have a length dimension and a lateral dimension wherein the length dimension is the longer of the two dimensions and the lateral dimension is transverse to the length dimension. The aspect ratio of such crystals is determined by the ratio of the length dimension to the lateral dimension. In some aspects, at least 30% of the crystals have an aspect ratio of more than 5, such as 5.1 or more, such as 5.3 or more, such as 5.5 or more, such as 6 or more, such as 6.5 or more, such as 7 or more, such as 7.5 or more, such as 8 or more, such as 8.5 or more, such as 9 or more, such as 9.5 or more, such as 10 or more, such as 13 or more, such as 15 or more, such as 20 or more, such as 25 or more, such as 30 or more, such as 40 or more, such as 50 or more. In some aspects, at least 30% of the gypsum crystals may have an aspect ratio of 100 or less, such as 90 or less, such as 80 or less, such as 70 or less, such as 60 or less, such as 50 or less, such as 40 or less, such as 30 or less, such as 25 or less, such as 20 or less, such as 15 or less, such as 13 or less, such as 10 or less, such as 9.5 or less, such as 9 or less, such as 8.5 or less, such as 8 or less, such as 7.5 or less.

In some aspects, at least 30% of the crystals may have a lateral dimension that is less than 20% of the length dimension. For instance, at least 30% of the crystals may have a lateral dimension that is less than 20%, such as 19% or less, such as 18% or less, such as 17% or less, such as 16% or less, such as 15% or less, such as 14% or less, such as 13% or less, such as 12% or less, such as 11% or less, such as 10% or less, such as 9% or less, such as 8% or less, such as 7% or less, such as 6% or less, such as 5% or less, such as 4% or less, such as 3% or less, such as 2% or less, such as 1% or less of the length dimension. In some aspects, at least 30% of the gypsum crystals may have a lateral dimension that is 0.1% or more, such as 0.5% or more, such as 1% or more, such as 2% or more, such as 3% or more, such as 4% or more, such as 5% or more, such as 6% or more, such as 7% or more, such as 8% or more, such as 9% or more, such as 10% or more, such as 11% or more, such as 12% or more, such as 13% or more, such as 14% or more, such as 15% or more, such as 16% or more, such as 17% or more of the length dimension.

Notably, the aforementioned disclosure references the aspect ratio and the length and lateral dimensions with respect to at least 30% of the gypsum crystals. However, in some aspects, the aforementioned disclosure may be realized for at least 40%, such as at least 50%, such as at least 60%, such as at least 70%, such as at last 75%, such as at least 80%, such as at least 85%, such as at least 90%, such as at least 93%, such as at least 95% of the gypsum crystals.

The gypsum crystals may have a specific surface area as determined using conventional techniques known in the art, such as a standard BET analysis. The specific surface area may be 0.5 m²/g or more, such as 0.6 m²/g or more, such as 0.7 m²/g or more, such as 0.8 m²/g or more, such as 0.9 m²/g or more, such as 1 m²/g or more, such as 1.1 m²/g or more, such as 1.2 m²/g or more, such as 1.3 m²/g or more, such as 1.4 m²/g or more, such as 1.5 m²/g or more, such as 1.6 m²/g or more, such as 1.7 m²/g or more, such as 1.8 m²/g or more, such as 1.9 m²/g or more, such as 2 m²/g or more. The specific surface area may be 5 m²/g or less, such as 4.5 m²/g or less, such as 4 m²/g or less, such as 3.5 m²/g or less, such as 3 m²/g or less, such as 2.8 m²/g or less, such as 2.6 m²/g or less, such as 2.5 m²/g or less, such as 2.4 m²/g or less, such as 2.2 m²/g or less, such as 2 m²/g or less, such as 1.9 m²/g or less, such as 1.7 m²/g or less, such as 1.5 m²/g or less, such as 1.3 m²/g or less, such as 1.1 m²/g or less.

By providing gypsum crystals having the aforementioned size distribution and thus controlling the crystal morphology, various attributes may be realized. For instance, the mechanical and physical properties of the board may be improved. For instance, by providing a gypsum board having gypsum crystals with a relatively high aspect ratio, the strength of the gypsum board may be enhanced. In addition or alternatively, the board weight may be reduced while retaining or improving upon the physical and/or mechanical properties. Furthermore, raw material usage in the formation of the board may also be reduced.

As indicated herein, the present disclosure discloses a gypsum board. The gypsum board may include a gypsum core. The gypsum core may be formed from a gypsum slurry. The gypsum core may have a gypsum layer surface. In particular, the gypsum layer surface may include a first gypsum layer surface and a second gypsum layer surface opposing the first gypsum layer surface. A facing material may be provided on the gypsum layer surface. For instance, a first facing material may be provided on the first gypsum layer surface, and a second facing material may be provided on the second gypsum layer surface. In this regard, the first facing material and the second facing material may sandwich the gypsum core.

The composition of the gypsum slurry and gypsum core is not necessarily limited and may be any generally known in the art. In some aspects, the gypsum core is made from a gypsum slurry including at least stucco and water. In this regard, the method may also include a step of combining stucco, water, and any other optional additives as mentioned herein. In general, stucco may be referred to as calcined gypsum or calcium sulfate hemihydrate. Notably, calcined gypsum or calcium sulfate hemihydrate is conventionally prepared by grinding and calcining gypsum at relatively high temperatures. Typically, when the gypsum undergoes calcination and rehydration, the gypsum crystals are formed in a needle-shape (e.g., acicular). A gypsum core comprising gypsum crystals in accordance with the present disclosure may include needle-shaped gypsum crystals having a particular size and/or aspect ratio, such as any size and/or aspect ratio disclosed herein.

The aspect ratio and size of the gypsum crystals can be controlled using various means. For example, modifications may be made to the process of producing the calcined gypsum or the gypsum slurry in order to provide gypsum crystals that have a relatively high aspect ratio and are finer in general. In one embodiment, the process of producing the calcined gypsum may be modified. In another embodiment, the gypsum slurry may be modified. In a further embodiment, the process of producing the calcined gypsum and the gypsum slurry may be modified. In general, more than one of the modifications may be utilized to control the aspect ratio of the gypsum crystals. For instance, the description below provides various means that allow for such modifications. In this regard, a combination of such means may be utilized in order to better control the morphology and aspect ratio of the gypsum crystals.

In some aspects, the gypsum slurry may be modified in order to provide gypsum crystals that have a relatively high aspect ratio and are finer in general. For example, the gypsum slurry temperature may be reduced to control the growth of the gypsum crystals to provide a higher aspect ratio as described herein. For example, a decrease in the gypsum slurry temperature may result in an increase in the aspect ratio and/or the specific surface area of the gypsum crystals. The gypsum slurry temperature may be 130 °F or less, such as 120 °F or less, such as 115 °F or less, such as 100 °F or less, such as 85 °F or less, such as 70 °F or less, such as 60 °F or less, such as 50 °F or less, such as 45 °F or less. The gypsum slurry temperature may be 40 °F or more, such as 50 °F or more, such as 60 °F or more, such as 70 °F or more, such as 80 °F or more, such as 90 °F or more, such as 100 °F or more.

In some aspects, a relatively high aspect ratio and fineness of the gypsum crystals may be realized by providing an increase in the number of crystal nucleating sites. For instance, this may be achieved by providing a finer gypsum-based accelerator and/or increasing the concentration of the gypsum-based accelerator within the gypsum slurry. For example, an increase in the concentration of the accelerator may result in an increase in the aspect ratio and/or the specific surface area of the gypsum crystals. The accelerator may be present in an amount of 0.05 wt. % or more, such as 0.1 wt. % or more, such as 0.15 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the stucco in the gypsum slurry. The accelerator may be present in an amount of 2 wt. % or less, such as 1.8 wt. % or less, such as 1.6 wt. % or less, such as 1.4 wt. % or less, such as 1.2 wt. % or less, such as 1 wt. % or less, such as 0.9 wt. % or less, such as 0.7 wt. % or less, such as 0.5 wt. % or less, such as 0.3 wt. % or less, such as 0.1 wt. % or less based on the weight of the stucco in the gypsum slurry. Alternatively, the aforementioned values may be based on the weight of the gypsum in the gypsum core.

An accelerator may be any accelerator, including land plaster and/or ball mill accelerator (BMA), which may be a combination of finely ground gypsum and one or more grinding aids, such as starches (e.g., starch and pregelatinized starch), sugars (e.g., dextrose, sucrose, sugar, and soluble dextrin), lignosulfonates, beta naphthalene sulfonate formaldehyde condensates (e.g., BNS and PNS), water reducing agents, fatty acids, and/or metallic soaps (e.g., stearic acid, calcium stearate, and magnesium stearate). The accelerator may comprise one or more grinding agents, such as boric acid, polyphosphates, phosphate salts (e.g., STMP, STPP, TSPP, TKPP, and KTPP), organic phosphonic compounds, wet ground phosphate systems, set retarders, secondary accelerators (e.g., potash and aluminum sulfate), various organic acids, polycarboxylate ethers (PCE), sulfonated melamine polycondensates (e.g., SMP and SMF), and other modifiers, such as those included by reference from U.S. Pat. No. 11,446,620, which is incorporated herein by reference in its entirety.

Gypsum set accelerators typically comprise dried, finely ground gypsum (also referred to as “land plaster”). This gypsum source may be either synthetic (e.g., a byproduct of an industrial process) or naturally occurring. The land plaster particles may serve as seed crystals that promote the stucco hydration reaction and cause the calcium sulfate dihydrate crystals to form at a faster rate. Land plaster used in gypsum accelerators may be produced in stages. The first step may include drying the gypsum to remove any free moisture. The second step may include fine milling performed in a ball mill or other grinding mills with different types of grinding aids. In general, the finer the land plaster particles, the more effective the accelerator.

In some aspects, a relatively high aspect ratio may be realized by increasing the calcium to sulfate ratio in the gypsum slurry (e.g., to a ratio of greater than 1). For example, an increase in the water to stucco ratio may result in an increase in the aspect ratio and/or the specific surface area of the gypsum crystals. The ratio may be greater than 1, such as 1.05 or more, such as 1.1 or more, such as 1.2 or more, such as 1.3 or more, such as 1.5 or more, such as 1.7 or more, such as 2 or more, such as 3 or more, such as 5 or more, such as 10 or more. The aforementioned ratio in one embodiment may refer to an atomic ratio. The aforementioned ratio in another embodiment may refer to a molar ratio. This increase in ratio may be realized by providing additional calcium salts or calcium neutralized polymers, such as polynapthalene sulfonate. For example, these salts may include, but are not limited to, calcium chloride, calcium nitrate, calcium acetate, calcium carbonate, calcium bicarbonate, calcium hydroxide, calcium nitrate, calcium iodide, calcium fluoride, calcium phosphate, calcium formate, calcium citrate, calcium lactate, calcium gluconate, etc. as well as mixtures thereof.

In another embodiment, the process of producing the calcined gypsum may be modified in order to provide gypsum crystals that have a relatively high aspect ratio and are finer in general. For example, the calcined gypsum or stucco may be manipulated such that it may be finer. For example, once calcined, the gypsum (in the form of calcium sulfate hemihydrate) may be further ground using various means (e.g., ball, tube, impact mill, entoleter, etc.). In this regard, in one embodiment, the gypsum may be subjected to ball milling using certain ball sizes. It should be understood that the present invention may not necessarily be limited by the particular ball size and/or duration of milling and/or type of milling. For instance, the milling may be conducted using a ball size of 0.125 inches or more, such as 0.25 inches or more, such as 0.375 inches or more, such as 0.5 inches or more in diameter. The ball size may be 1 inch or less, such as 0.75 inches or less, such as 0.625 inches or less, such as 0.5 inches or less, such as 0.375 inches or less, such as 0.25 inches or less in diameter. The milling duration may be 0.01 hours or more, such as 0.1 hours or more, such as 0.2 hours or more, such as 0.3 hours or more, such as 0.5 hours or more, such as 0.8 hours or more, such as 1 hour or more. The milling duration may be 5 hours or less, such as 4 hours or less, such as 3 hours or less, such as 2 hours or less, such as 1.5 hours or less, such as 1.2 hours or less, such as 1 hour or less, such as 0.9 hours or less, such as 0.7 hours or less, such as 0.5 hours or less. In addition, the loading may be 1,000 lbs or more, such as 2,000 lbs or more, such as 3,000 lbs or more, such as 4,000 lbs or more, such as 5,000 lbs or more, such as 7,000 lbs or more. The loading may be 15,000 lbs or less, such as 13,000 lbs or less, such as 10,000 lbs or less, such as 9,000 lbs or less, such as 7,000 lbs or less. The balls may be made of steel, a ceramic, or a mixture thereof. For instance, the balls may be made of a steel, such as a chrome steel, a stainless steel, a carbon steel, etc. The balls may alternatively be made of a ceramic, such as alumina, a silicate (e.g., zirconium silicate), a carbide (e.g., tungsten carbide), etc.

The fineness may also be controlled by controlling the rate of calcination (e.g., reducing or increasing the rate of calcination). The calcination may be flash calcination, rotary kiln calcination, fluidized bed calcination, or kettle calcination. For instance, in one embodiment, the calcination may be flash calcination. In another embodiment, the calcination may be kettle calcination. Without intending to be limited by theory, the former may be conducted over a relatively shorter period of time than the latter. In addition, without intending to be limited by theory, flash calcination may generally produce more reactive stucco, while kettle calcination may allow for producing stucco with a lower water demand.

The aspect ratio may also be controlled by optimizing crystal modifier usage and type (e.g., reducing the usage of potassium sulfate, aluminum sulfate, aridizing agents, and the like). The crystal modifiers may include crystal salts and other compounds such as finely ground gypsum dihydrate (e.g., Terra Alba, landplaster, gypsum seed), potassium sulfate, aluminum sulfate, potash, citric acid and citrate salts, tartaric acid and tartrate salts, protein hydrolysates, glue based retarders, polyphosphates and phosphate salts (e.g., STMP, STPP, and TSPP), boric acid, borax, borate salts, modified amino acid retarders, carboxylic acids for gypsum crystal habit control (e.g., citric acid and adipic acid), alpha hemihydrate habit modifiers (e.g., succinic acid, malic acid, maleic acid, and succinate systems), simple soluble salts used as accelerators and/or habit modifiers (e.g., sodium chloride, sodium sulfate, and magnesium sulfate), zinc sulfate and ground gypsum dihydrate catalyst systems, chelating agents, and mixtures thereof. Suitable chelating agents may include phosphates (e.g., tripolyphosphates), phosphonic acids (e.g., hydroxyethylenediphosphonic acid), polyamines (e.g., ethylenediamine and salts thereof), aminocarboxylic acids (e.g., ethylenediaminetetraacetic acid), diketones (e.g., acetylacetone), hydroxycarboxylic acids (e.g., tartaric acid and citric acid), aminoalcohols (e.g., triethanolamine), sulfur compounds (e.g., thiourea), and mixtures thereof. When utilized, such crystal modifiers (e.g., chelating agents) may be present in an amount of 0.05 wt. % or more, such as 0.1 wt. % or more, such as 0.15 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the stucco in the gypsum slurry. The crystal modifiers (e.g., chelating agents) may be present in an amount of 2 wt. % or less, such as 1.8 wt. % or less, such as 1.6 wt. % or less, such as 1.4 wt. % or less, such as 1.2 wt. % or less, such as 1 wt. % or less, such as 0.9 wt. % or less, such as 0.7 wt. % or less, such as 0.5 wt. % or less, such as 0.3 wt. % or less, such as 0.1 wt. % or less based on the weight of the stucco in the gypsum slurry. Alternatively, the aforementioned values may be based on the weight of the gypsum in the gypsum core.

Regarding the aforementioned aridizing agents, aridizing agents that may be utilized include, but are not limited to, sodium monofluorophosphate, sodium trimetaphosphate, sodium tripolyphosphate, sodium phosphate monobasic, sodium phosphate tribasic, sodium aluminum sulfate, ammonium polyphosphate, ammonium phosphate monobasic, ammonium phosphate dibasic, ammonium sulfate, calcium chloride, potassium chloride, sodium hydroxide, potassium carbonate, ferric chloride, ferric nitrate, boric acid, calcium carbonate, potassium sulfate, calcium phosphate monobasic, potassium phosphate tribasic, aluminum sulfate, tartaric acid, citric acid, sodium borate, sodium phosphate tribasic dodecahydrate, calcium phosphate dibasic, calcium nitrate tetrahydrate, urea, talc, sodium metaborate, boric oxide, and aluminum dihydrogen phosphate, etc. as well as mixtures thereof. When utilized, such aridizing agents may be present in an amount of 0.05 wt. % or more, such as 0.1 wt. % or more, such as 0.15 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the stucco in the gypsum slurry. The aridizing agents may be present in an amount of 2 wt. % or less, such as 1.8 wt. % or less, such as 1.6 wt. % or less, such as 1.4 wt. % or less, such as 1.2 wt. % or less, such as 1 wt. % or less, such as 0.9 wt. % or less, such as 0.7 wt. % or less, such as 0.5 wt. % or less, such as 0.3 wt. % or less, such as 0.1 wt. % or less based on the weight of the stucco in the gypsum slurry. Alternatively, the aforementioned values may be based on the weight of the gypsum in the gypsum core.

In general, such aridizing agents may be combined with gypsum during or prior to calcination. In one embodiment, such agents are provided (e.g., mixed) with the gypsum prior to calcination. In another embodiment, such agents are provided (e.g., mixed) with the gypsum during calcination.

Notably, the aspect ratio may be controlled by utilizing one or more additives or components disclosed in U.S. Pat. No. 11,446,620 or 11,498,872, both of which are incorporated herein by reference in their entirety. In some aspects, the aspect ratio may be controlled by utilizing one or more additives or components disclosed in U.S. Patent Publication No. 2024/0254044, which is incorporated herein by reference in its entirety.

Further, the aspect ratio may be controlled by utilizing stucco cooling or conditioning after stucco production. Such cooling may be air cooling or water cooling. In one embodiment, the cooling may be air cooling. In another embodiment, the cooling may be water cooling. In yet another embodiment, the stucco may be conditioned by exposure to water vapor or water droplets. Notably, the stucco may be conditioned in accordance with the methods of U.S. Pat. No. 9,221,026, which is incorporated herein by reference in its entirety. Without intending to be limited, in general, the cooler the slurry, the finer the crystals. In addition, the stucco may be cooled prior to hydration, such as through forced air introduction, conditioning, storing in bins/silos, etc. In addition, the stucco may be cooled during hydration using cooler hydration mediums such as water chillers as well as seasonal ambient conditions. Such conditioning of the stucco may include healing of the stucco crystal surfaces and converting any soluble anhydrite to less reactive calcium sulfate hemihydrate. In one embodiment, this may be allowed by controlling the humidity. For instance, the relative humidity may be 50% or more, such as 60% or more, such as 70% or more, such as 80% or more, such as 90% or more. Without intending to be limited by theory, the humidity may convert and reduce the activity of reactive gypsum phases, such as soluble anhydrite and allow for a reduction in reactivity and the water demand of the stucco. This may reduce the surface energy, resulting in smoother and finer gypsum crystals. Without intending to be limited by theory, such conditioning may effectively increase the water to stucco ratio of the slurry while reducing its water demand.

Notably, the gypsum crystals may be provided with an additive comprising a binder. In this respect, the gypsum slurry may include a binder, such as any of the binders disclosed herein, including any properties thereof. The binder may be an organic binder, an inorganic binder, or a mixture thereof. For example, in one embodiment, the binder may be an organic binder. In another embodiment, the binder may be an inorganic binder. In addition, the binder may be a natural binder or a synthetic binder. For instance, in one embodiment, the binder may be a natural binder. In another embodiment, the binder may be a synthetic binder. Without intending to be limited, the binder may assist with binding the matrix including the gypsum crystals.

As indicated above, the binder may be an organic binder. In this regard, the binder may comprise a vegetable derived organic binder. The binder may be one based on triglycerides derived from polyunsaturated fatty acids from plant or vegetable oils. The binder may include, but is not limited to, soy protein, pine resins (e.g., rosins, terpenes, terpene-phenol resins, rosin ester resins, etc., starch, starch derivatives, and modified latex (e.g., modified natural rubber latex, etc.). In one embodiment, the binder comprises starch, soy protein, or a mixture thereof. For instance, the binder may comprise a starch, such as a pre-gelatinized starch, a non-pre-gelatinized starch, or a mixture thereof. In another embodiment, the binder may comprise a soy protein. The binder may be one obtained from a petrochemical. For instance, the binder may be an aliphatic or aromatic hydrocarbon resin, a xylene resin, a phenol resin, a coumarone-indene resin, etc., or a mixture thereof.

In one embodiment, the binder may be an inorganic binder. In this regard, the inorganic binder may refer to certain cementitious materials that are mentioned herein. For instance, the inorganic binder may include, but is not limited to, clays, cement, lime stucco, a pozzolan, soluble silicates, magnesium cements, etc., or a mixture thereof.

Notably, a binder may be present in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The binder may be present in an amount of 20 wt. % or less, such as 15 wt. % or less, such as 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum board. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

As indicated herein, a combination of the aforementioned methods and/or additives may be utilized in order to better control the morphology and aspect ratio of the gypsum crystals. Just as examples, modifications may be made based on accelerators and/or stucco grinding. In addition or alternatively, modifications may be made based on crystal modifiers and/or water to stucco ratios. In addition or alternatively, modifications may be made by stucco conditioning and/or cooling.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellents (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc. ; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum board. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

In general, the gypsum, in particular the calcium sulfate dihydrate, may be present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum may be present in the gypsum core in an amount of 100 wt. % or less, such as 99 wt. % or less, such as 98 wt. % or less, such as 95 wt. % or less, such as 90 wt. % or less. In another embodiment, the aforementioned weight percentages are based on the weight of the gypsum board. It should be understood that the gypsum used to make the gypsum core may be from a natural source, a synthetic source, and/or from reclaim and is thus not necessarily limited by the present invention.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material. In some aspects, the gypsum core may include components from a reclaim facing material, such as paper fibers or glass fibers from a reclaim facing material.

The gypsum core may be formed from a gypsum slurry. As previously disclosed herein, the gypsum slurry may include stucco. In general, stucco may be referred to as calcined gypsum or calcium sulfate hemihydrate. The calcined gypsum may be from a natural source, a synthetic source, and/or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate may be present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material. In some aspects, the gypsum slurry may include components from a reclaim facing material, such as paper fibers or glass fibers from a reclaim facing material.

As previously disclosed herein, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellents (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc. ; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the solids content of the gypsum slurry. In some aspects, the aforementioned weight percentages may be based on the weight of the stucco in the gypsum slurry.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in some aspects, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In some aspects, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum board and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In some aspects, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In some aspects, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in some aspects, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In some aspects, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more dispersants. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether, and in particular a polycarboxylate ether, or a carboxylate ester, and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In some aspects, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In some aspects, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta-and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate and/or olefin sulfonate (e.g., sodium olefin sulfonates, such as sodium C₁₄-C₁₆ olefin sulfonate, sodium C₁₄-C₁₈ olefin sulfonate, and sodium C₁₆-C₁₈ olefin sulfonate), and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In some aspects, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono-or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In some aspects, the nonionic surfactant may be an amine oxide. In some aspects, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In some aspects, a surfactant may include an ethoxylated alcohol that may include carbon chain lengths ranging from 12 to 20 carbon atoms. For instance, an ethoxylated alcohol may include carbon chain lengths ranging from 12 to 20 carbon atoms. A surfactant may include a blend of ethoxylated alcohols that have carbon chain lengths ranging from 12 to 20 carbon atoms. For instance, surfactant may include a blend of ethoxylated alcohols having carbon chain lengths ranging from 12 to 20 carbon atoms.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

In some aspects, the gypsum slurry and/or gypsum core may include one or more starches. The starch may be one generally utilized in the art. Such starch may be combined with the stucco and water. In this regard, such starch may be present in the gypsum slurry as well as the resulting gypsum core and gypsum board. In some aspects, one or more components of a gypsum board may be free of starch. For instance, the gypsum core and/or gypsum slurry may be free of starch. In some aspects, a gypsum board formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum board, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60 °C or more, such as 80 °C or more, such as 100 °C or more. The gelling temperature may be 120 °C or less, such as 100 °C or less, such as 80 °C or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In some aspects, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

As previously disclosed herein, the gypsum core may be sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another embodiment, the facing material may be a metal facing material (e.g., an aluminum facing material). For instance, both the first and second facing materials may be a metal facing material (e.g., an aluminum facing material). In some aspects, the first and second facing materials may be different.

In one aspect, the first facing material and the second facing material may comprise the same binder (e.g., a polymeric binder). In another aspect, the first facing material and the second facing material may comprise a different binder. In an additional aspect, the first facing material and/or the second facing material may not comprise a polymeric binder.

The glass mat facing material in one embodiment may be coated. However, in one particular embodiment, the glass mat facing material may not have a coating, such as a coating that is applied to the surface of the mat.

In general, a gypsum board formed in accordance with the present disclosure may be formed from a method as disclosed herein. For instance, in the method of making a gypsum board, a first facing material may be provided wherein the first facing material has a first facing material surface and a second facing material surface opposite the first facing material surface. The first facing material may be conveyed on a conveyor system (i.e., a continuous system for continuous manufacture of gypsum board). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum board.

The manner in which the components of the gypsum slurry are combined is not necessarily limited. For instance, the gypsum slurry can be made using any method or device generally known in the art. In particular, the components of the gypsum slurry can be mixed or combined using any method or device generally known in the art. The components of the gypsum slurry may be combined in any type of device, such as a mixer and in particular a pin mixer or pinless mixer. In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, and as previously disclosed, the calcium sulfate hemihydrate of the stucco may react with the water to hydrate the calcium sulfate hemihydrate into calcium sulfate dihydrate. Such reaction may allow for the gypsum to set and become firm thereby allowing for the boards to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum board. In addition, during this process, the method may allow for dewatering of the gypsum slurry, in particular dewatering any free water instead of combined water of the gypsum slurry. Thereafter, the method may also comprise a step of cutting a continuous gypsum sheet into a gypsum board. Then, after the cutting step, the method may comprise a step of supplying the gypsum board to a heating or drying device. For instance, such a heating or drying device may be a kiln and may allow for the removal (e.g., evaporation) of any free water. The temperature and time required for drying in such heating device are not necessarily limited by the present disclosure.

In one embodiment, the gypsum core may include a first gypsum core layer and a second gypsum core layer. The first gypsum core layer may be between the first facing material (e.g., front of the board) and the second gypsum core layer. In addition, the first gypsum core layer may have a density greater than the second gypsum core layer. Accordingly, the first gypsum core layer may be formed using a gypsum slurry without the use of a foaming agent and/or foam or with a reduced amount of foaming agent and/or foam, which may be utilized in forming the second gypsum core layer. In this regard, in one embodiment, the first gypsum core layer may have the same composition as the second gypsum core layer except that the second gypsum core layer may be formed using a foaming agent and/or foam or a greater amount of foaming agent and/or foam.

In one embodiment, the gypsum core may also include a third gypsum core layer. The third gypsum core layer may be provided between the second gypsum core layer and a second facing material (e.g., back of the board). In some aspects, the third gypsum core layer may be located adjacent to the second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent and/or foam or with a reduced amount of foaming agent and/or foam, which may be utilized in forming the second gypsum core layer. In this regard, in one embodiment, the third gypsum core layer may have the same composition as the second gypsum core layer except that the second gypsum core layer may be formed using a foaming agent and/or foam or a greater amount of foaming agent and/or foam.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent and/or foam or more foaming agent and/or foam than the first gypsum slurry. In this regard, in one embodiment, the first gypsum slurry may not include a foaming agent and/or foam. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent and/or foam or more foaming agent and/or foam than the third gypsum slurry. In this regard, in one embodiment, the third gypsum slurry may not include a foaming agent and/or foam. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such a relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such a relationship may also be between the third gypsum core layer and the second gypsum core layer. In addition, in one embodiment, all of the gypsum core layers may have a different density.

Regardless of the above, any of the additives disclosed herein may be present in any combination of gypsum core layers. In some aspects, one or more gypsum core layers may comprise the same additive or additives. Further, in some aspects, the one or more gypsum core layers may comprise different additives. The different additives of the one or more gypsum core layers may be chosen such that it is advantageous to have a particular additive in one gypsum core layer and a different additive in another, different gypsum core layer.

The gypsum board disclosed herein may have many applications. For instance, the gypsum board may be used as a standalone board in construction for the preparation of walls, ceilings, floors, roofs, etc. As used in the present disclosure, the term “gypsum board,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum board forms part of a building structure, such as a wall or ceiling.

In one embodiment, the gypsum board may be processed such that any respective gypsum core layer may have an average void size of about 90 microns to about 1500 microns, such as about 90 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more. Generally, the average void size may be about 1,500 microns or less, such as about 1,300 microns or less, such as about 1,100 microns or less, such as about 1,000 microns or less, such as about 900 microns or less, such as about 800 microns or less, such as about 700 microns or less, such as about 600 microns or less, such as about 500 microns or less, such as about 400 microns or less, such as about 300 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 5 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more. The specific surface area of the gypsum core may be 5 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum board, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, the thickness may be about 1 inch. In addition, at least two gypsum boards may be combined to create another gypsum board, such as a composite gypsum board. For example, at least two gypsum boards having a thickness of about 5/16 inches each may be combined or sandwiched to create a gypsum board having a thickness of about ⅝ inches. While this is one example, it should be understood that any combination of gypsum boards may be utilized to prepare a sandwiched gypsum board. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the weight of the gypsum board is not necessarily limited. The gypsum board may have a weight of about 500 lbs/MSF to about 7000 lbs/MSF, including all increments of 1 lb/MSF therebetween. For instance, the gypsum board may have a weight of about 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2100 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such weight may be a dry board weight, such as after the board leaves the heating or drying device (e.g., kiln).

In addition, the gypsum board may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The board may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum board may have a certain nail pull resistance, which generally is a measure of the force required to pull a gypsum board off a wall by forcing a fastening nail through the board. The values obtained from the nail pull test generally indicate the maximum stress achieved while the fastener head penetrates through the board surface and core. In this regard, the gypsum board exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum board. For instance, when conducting a test, such nail pull resistance values may vary depending on the thickness of the gypsum board. As an example, the nail pull resistance values above may be for a ⅝ inch board. However, it should be understood that instead of a ⅝ inch board, such nail pull resistance values may be for any other thickness gypsum board as mentioned herein.

The gypsum board may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum board. For instance, when conducting a test, such compressive strength values may vary depending on the thickness of the gypsum board. As an example, the compressive strength values above may be for a ⅝ inch board. However, it should be understood that instead of a ⅝ inch board, such compressive strength values may be for any other thickness gypsum board as mentioned herein.

In addition, the gypsum board may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum board may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum board may have an end hardness according to the aforementioned values. Such core hardness may be based upon the thickness of the gypsum board. For instance, when conducting a test, such core hardness values may vary depending on the thickness of the gypsum board. As an example, the core hardness values above may be for a ⅝ inch board. However, it should be understood that instead of a ⅝ inch board, such core hardness values may be for any other thickness gypsum board as mentioned herein.

In addition, the gypsum board may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum board may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum board. For instance, when conducting a test, such edge hardness values may vary depending on the thickness of the gypsum board. As an example, the edge hardness values above may be for a ⅝ inch board. However, it should be understood that instead of a ⅝ inch board, such edge hardness values may be for any other thickness gypsum board as mentioned herein.

In addition, as previously disclosed, it may also be desired to have an effective bond between the facing material and the gypsum core. Typically, a humidified bond test is performed for 2 hours in a humidity chamber at 90 °F and 90% humidity. In this test, after exposure, the facing material is removed to determine how much remains on the gypsum board. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum board. Alternatively, such percentage may be for a back of the gypsum board. Further, such percentages may apply to the face and the back of the gypsum board. In addition, such values may be for an average of at least 3 gypsum boards, such as at least 5 gypsum boards.

Also, it may be desired to have a particular humidified deflection based on exposure in an atmosphere of 90 °F±3 °F and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum boards.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum board comprising:
a gypsum core and a facing material, wherein the gypsum core includes calcium sulfate dihydrate crystals having a length dimension and a lateral dimension transverse the length dimension, wherein the lateral dimension is less than 20% of the length dimension for at least 30% of the calcium sulfate dihydrate crystals.

2. The gypsum board of claim 1, wherein the lateral dimension is less than 20% of the length dimension for at least 50% of the calcium sulfate dihydrate crystals.

3. The gypsum board of claim 1, wherein the lateral dimension is less than 20% of the length dimension for at least 75% of the calcium sulfate dihydrate crystals.

4. The gypsum board of claim 1, wherein the lateral dimension is less than 15% of the length dimension for at least 50% of the calcium sulfate dihydrate crystals.

5. The gypsum board of claim 1, wherein the lateral dimension is less than 15% of the length dimension for at least 75% of the calcium sulfate dihydrate crystals.

6. The gypsum board of claim 1, wherein the lateral dimension is less than 10% of the length dimension for at least 30% of the calcium sulfate dihydrate crystals.

7. The gypsum board of claim 1, wherein the lateral dimension is less than 10% of the length dimension for at least 50% of the calcium sulfate dihydrate crystals.

8. The gypsum board of claim 1, wherein the lateral dimension is less than 10% of the length dimension for at least 75% of the calcium sulfate dihydrate crystals.

9. The gypsum board of claim 1, wherein at least 30% of the calcium sulfate dihydrate crystals have an aspect ratio of more than 5.

10. The gypsum board of claim 1, wherein at least 50% of the calcium sulfate dihydrate crystals have an aspect ratio of more than 5.

11. The gypsum board of claim 1, wherein at least 75% of the calcium sulfate dihydrate crystals have an aspect ratio of more than 5.

12. The gypsum board of claim 1, wherein at least 30% of the calcium sulfate dihydrate crystals have an aspect ratio of more than 10.

13. The gypsum board of claim 1, wherein at least 75% of the calcium sulfate dihydrate crystals have an aspect ratio of more than 10.

14. The gypsum board of claim 1, wherein at least 85% of the calcium sulfate dihydrate crystals have an aspect ratio of more than 10.

15. The gypsum board of claim 1, wherein the gypsum core has a gypsum layer surface including a first gypsum layer surface and a second gypsum layer surface opposing the first gypsum layer surface, wherein the facing material includes a first facing material provided on the first gypsum layer surface and a second facing material provided on the second gypsum layer surface.

16. The gypsum board of claim 1, wherein the gypsum core comprises a binder.

17. The gypsum board of claim 16, wherein the binder is present in an amount of from 0.0001 wt. % to 5 wt. % based on the weight of the gypsum board.

18. The gypsum board of claim 16, wherein the binder comprises an organic binder.

19. The gypsum board of claim 16, wherein the binder comprises a starch.

20. The gypsum board of claim 16, wherein the binder comprises an inorganic binder.

21. The gypsum board of claim 1, wherein the calcium sulfate dihydrate crystals comprise from 50 wt. % to 98 wt. % of the gypsum core.

22. The gypsum board of claim 1, wherein the calcium sulfate dihydrate crystals comprise from 70 wt. % to 98 wt. % of the gypsum core.
